(19) United States
(12) Patent Application Publication
(10) Pub. No.: US 2013/0173586 A1
(43) Pub. Date: Jul. 4, 2013

(54) SYSTEM, METHOD, AND COMPUTER-READABLE MEDIUM FOR REDUCING RESPONSE TIME VARIATION IN A WORKLOAD MANAGEMENT SYSTEM

(71) Applicants: John Mark Morris, San Diego, CA (US); Douglas P. Brown, Rancho Santa Fe, CA (US); Donald Pederson, San Diego, CA (US)

(72) Inventors: John Mark Morris, San Diego, CA (US); Douglas P. Brown, Rancho Santa Fe, CA (US); Donald Pederson, San Diego, CA (US)

(21) Appl. No.: 13/415,027

(22) Filed: Mar. 8, 2012

Related U.S. Application Data
(60) Provisional application No. 61/580,965, filed on Dec. 28, 2011.

(51) Int. Cl. G06F 17/30

(52) U.S. Cl. 707/713; 707/E17.131

(57) ABSTRACT

A system, method, and computer readable medium are provided for reducing response time variation in a workload management system for a database system. When a query response is generated in response to a database query from a client, a determination may be made as to whether response time of the query response is less than a predetermined amount of time. Delivery of the query response to the client is delayed when an amount of time associated with the query response is less than the predetermined amount of time.

### CROSS REFERENCE TO RELATED APPLICATIONS

This application claims priority under 35 U.S.C. §119(e) to the following co-pending and commonly-assigned provisional patent application, which is incorporated herein by reference:

Provisional Patent Application Ser. No. 61/580,965, entitled “SYSTEM, METHOD, AND COMPUTER-READABLE MEDIUM FOR REDUCING RESPONSE TIME VARIATION IN A WORKLOAD MANAGEMENT SYSTEM” by John Mark Morris, Douglas P. Brown, and Donald Raymond Pederson; filed on Dec. 28, 2011.

### TECHNICAL FIELD

The present disclosure relates to workload management of database systems, and is particularly directed to a system, method, and computer-readable medium for reducing response time variation in a workload management system.

### BACKGROUND

Modern database systems execute a variety of query requests concurrently and operate in a dynamic environment of cooperative systems, each comprising of numerous hardware components subject to failure or degradation. The need to regulate concurrent hardware and software ‘events’ has led to the development of a field which may be generically termed ‘Workload Management’.

Workload management techniques focus on managing or regulating a multitude of individual yet concurrent requests in a database system by effectively controlling resource usage within the database system. Resources may include any component of the database system, such as CPU (central processing unit) usage, hard disk or other storage means usage, or I/O (input/output) usage. Workload management techniques fall short of implementing a full system regulation, as they do not manage unforeseen impacts, such as unplanned situations (e.g. a request volume surge, the exhaustion of shared resources, or external conditions like component outages) or even planned situations (e.g. systems maintenance or data load).

A database of a database system is a collection of stored data that is logically related and that is accessible by one or more users or applications. A popular type of database is the relational database management system (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

Some database users require conformance to Service Level Goals (SLGs) of response time for database transactions (i.e., queries or updates). Often the SLG is expressed as a percentage (called Service Percent (SP)) of queries that must complete within a response time T. The SP percentage could be any number, but is often expressed as number of “nines” of conformance, as is the practice in high availability. 99% or “two nines” SLG means that at least 99 of 100 queries must be completed in time T or less. Similarly, “four nines” SLG means that 9999 of 10,000 queries must be completed in time T or less.

Also, some database users have a use case that demands even more specificity. These database users would like to tighten the variance of response time. For example, a database user may say they want a “three nines” conformance to response time SLG of 3 to 5 seconds. This means that 999 of 1000 queries must return a query response in the range of 3 to 5 seconds. It should be noted that this specification considers a query to escape the SLG if a query returns in less than 3 seconds or greater than 5 seconds.

A database user may prefer a range-based SLG specification for a number of use cases. One use case may be where a very consistent response time is important to the end-user. Another use case may be where the information technology (IT) department does not want the user to become delighted with a fast response time much better than the SLG only to have it degrade toward SLG when a new application is added. Yet another use case may be where IT hosts multiple user communities or applications who present periodic or cyclic workloads, and IT does not want one user community to be impacted or sense the presence of other workloads on the system because it may lead to dissatisfaction. An example use case is when a database user says “Response is great in the morning, but slows when the west coast comes online”. Still another use case may be where it is desired to maintain consistent response times while the system is undergoing periodic capacity-on-demand operations.

One of the goals of a database management system is to optimize the performance of queries for access and manipulation of data stored in the database. The response time is the amount of time it takes to complete the execution of a query on a given system. Given a target environment, an optimal query plan is selected, with the optimal query plan being the one with the lowest cost (e.g., response time) as determined by an optimizer. However, selecting a query plan with the lowest response time may not conform to a range-based SLG of response time for database trasnactions, especially when tightening variance of response time is desired. It would be desirable to balance a need to optimize query plans and a need to tighten variance of response time during operation of a database system.

### SUMMARY

Disclosed embodiments provide a system, method, and computer readable medium for reducing response time variation in a workload management system for a database system. When a query response is generated in response to a database query from a client, a determination may be made as to whether response time of the query response is less than a first predetermined amount of time. Delivery of the query response to the client is delayed when an amount of time associated with the query response is less than the first predetermined amount of time. A determination may be made as to whether response time of the query response is greater than a second predetermined amount of time which is greater than the first predetermined amount of time. The query is aborted when an amount of time associated with the query response is greater than the second predetermined amount of time. Each of the first and second predetermined amounts of time is within a Service Level Goal (SLG) range specification of the workload management system for the database system.

### BRIEF DESCRIPTION OF THE DRAWINGS

Aspects of the present disclosure are best understood from the following detailed description when read with the accompanying figures, in which

FIG. 1 depicts a diagrammatic representation of an exemplary architecture for a large database system that is suited for implementing tightened variance of response times for database queries in accordance with disclosed embodiments.

FIG. 2 is a diagrammatic representation of a parsing engine implemented in accordance with an embodiment.

FIG. 3 is a diagrammatic representation of parser processing implemented in accordance with an embodiment.

FIGS. 4 and 5 are block diagrams of a workload management system for administering workload of a database system.

FIG. 6 is a flowchart that depicts processing of an example database query routine to facilitate performance enhancement in a workload management system in accordance with an embodiment.

FIG. 7 is a flowchart that depicts processing of another example database query routine to facilitate performance enhancement in a workload management system in accordance with an embodiment.

FIG. 8 is a flowchart that depicts processing of yet another example database query routine to facilitate performance enhancement in a workload management system in accordance with an embodiment.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

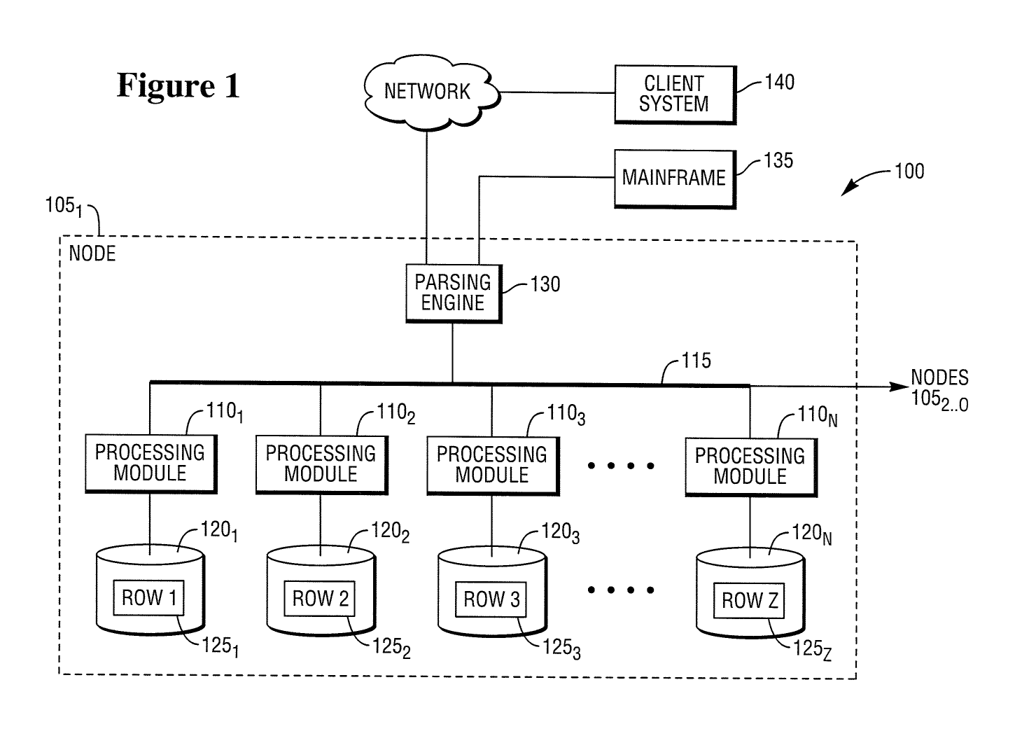

FIG. 1 depicts a diagrammatic representation of an exemplary architecture for a large database system (DBS) 100, such as a Teradata Active Data Warehousing System, that is suited for implementing tightened variance of response times for database queries in accordance with disclosed embodiments. The database system 100 includes a relational database management system (RDBMS) built upon a massively parallel processing (MPP) system. Other types of database systems, such as object-relational database management systems (ORDBMS) or those built on symmetric multi-processing (SMP) platforms, are also suited for use. The depicted and described architecture is exemplary only and is chosen to facilitate an understanding of the disclosed embodiments.

Many millions or billions of records may be managed by the database system 100. FIG. 1 shows a sample architecture for one node 105₁ of the DBS 100. The DBS node 105₁ includes one or more processing modules 110₁ . . . _{N}, connected by a network 115 that manage the storage and retrieval of data in data storage facilities 120₁ . . . _{N}. Each of the processing modules 110₁ . . . _{N} may be one or more physical processors or each may be a virtual processor, with one or more virtual processors running on one or more physical processors.

The system stores data in one or more tables in the data storage facilities 120₁ . . . _{N}. The rows 125₁ . . . _{z} of the tables are stored across multiple data storage facilities 120₁ . . . _{N} to ensure that the system workload is distributed evenly across the processing modules 110₁ . . . _{N}. A parsing engine 130 organizes the storage of data and the distribution of table rows 125₁ . . . _{z} among the processing modules 110₁ . . . _{N}. The parsing engine 130 also coordinates the retrieval of data from the data storage facilities 120₁ . . . _{N} in response to queries received from a user at a mainframe 135 or a client computer 140. The DBS 100 usually receives queries in a standard format, such as SQL.

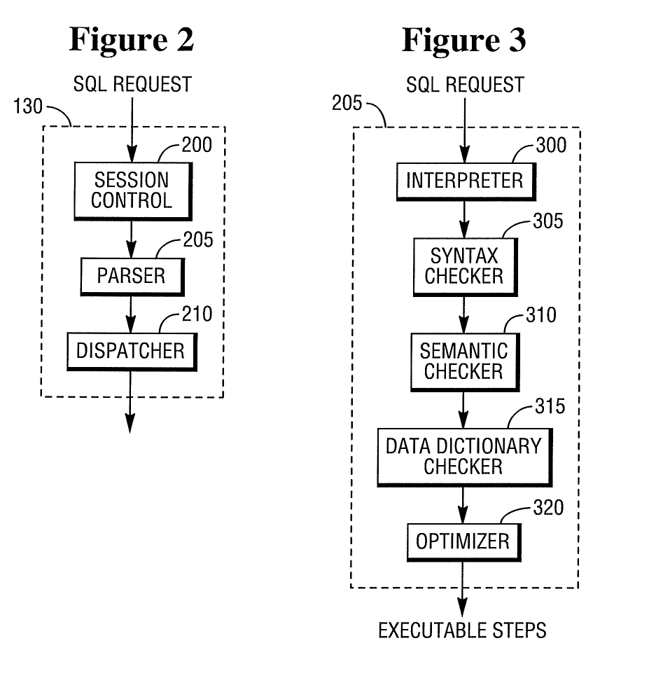

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

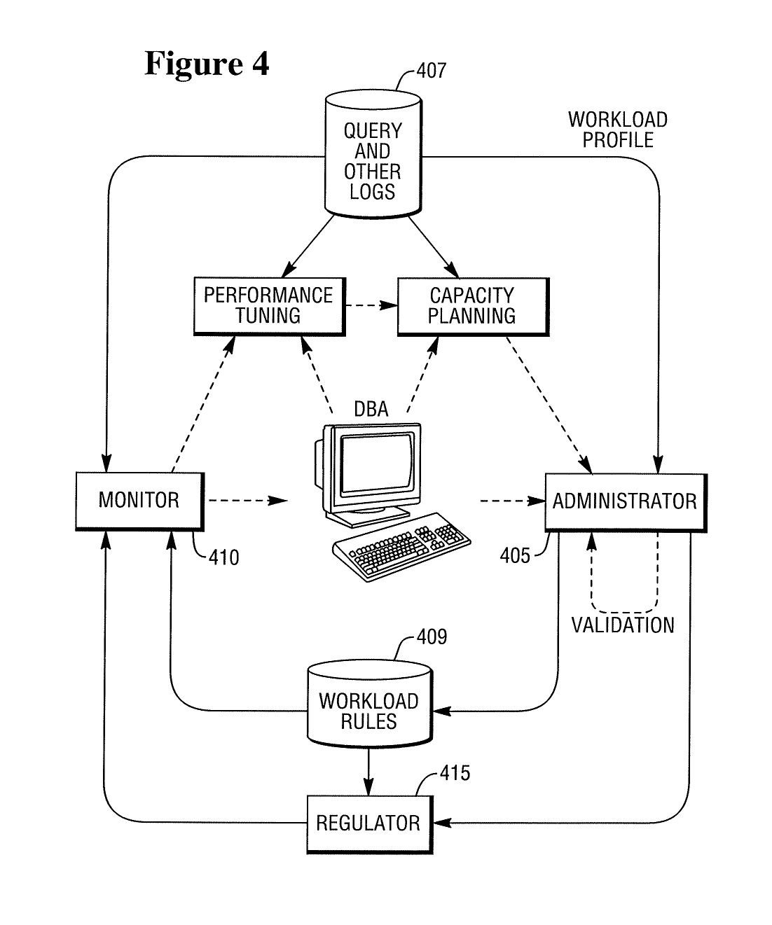

Once the session control 200 allows a session to begin, a user may submit a SQL request that is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315). Finally, the parser 205 runs an optimizer (block 320) that develops the least expensive plan to perform the request.

The DBS described herein accepts performance goals for each workload as inputs, and dynamically adjusts its own performance, such as by allocating DBS resources and throttling back incoming work. In one example system, the performance parameters are called priority scheduler parameters. When the priority scheduler is adjusted, weights assigned to resource partitions and allocation groups are changed. Adjusting how these weights are assigned modifies the way access to the CPU, disk and memory is allocated among requests. Given performance objectives for each workload and the fact that the workloads may interfere with each other's performance through competition for shared resources, the DBS may find a performance setting that achieves one workload's goal but makes it difficult to achieve another workload's goal.

The performance goals for each workload will vary widely as well, and may or may not be related to their resource demands. For example, two workloads that execute the same application and DBS code could have differing performance goals simply because they were submitted from different departments in an organization. Conversely, even though two workloads have similar performance objectives, they may have very different resource demands.

The system includes a “closed-loop” workload management architecture capable of satisfying a set of workload-specific goals. In other words, the system is a goal-oriented workload management system capable of supporting complex workloads and capable of self-adjusting to various types of workloads. In Teradata, the workload management system is generally referred to as Teradata Active System Management (TASM).

The system's operation has four major phases: 1) assigning a set of incoming request characteristics to workload groups, assigning the workload groups to priority classes, and assigning goals (called Service Level Goals or SLGs) to the workload groups, 2) monitoring the execution of the workload groups against their goals, 3) regulating (adjusting and managing) the workload flow and priorities to achieve the SLGs, and 4) correlating the results of the workload and taking action to improve performance. The performance improvement can be accomplished in several ways: 1) through performance tuning recommendations such as the creation or change in index definitions or other supplements to table data, or to recollect statistics, or other performance tuning actions, 2) through capacity planning recommendations, for example increasing system power, 3) through utilization of results to enable optimizer self-learning, and 4) through recommending adjustments to SLGs of one workload to better complement the SLGs of another workload that it might be impacting. All recommendations can either be enacted automatically, or after “consultation” with the database administrator (DBA).

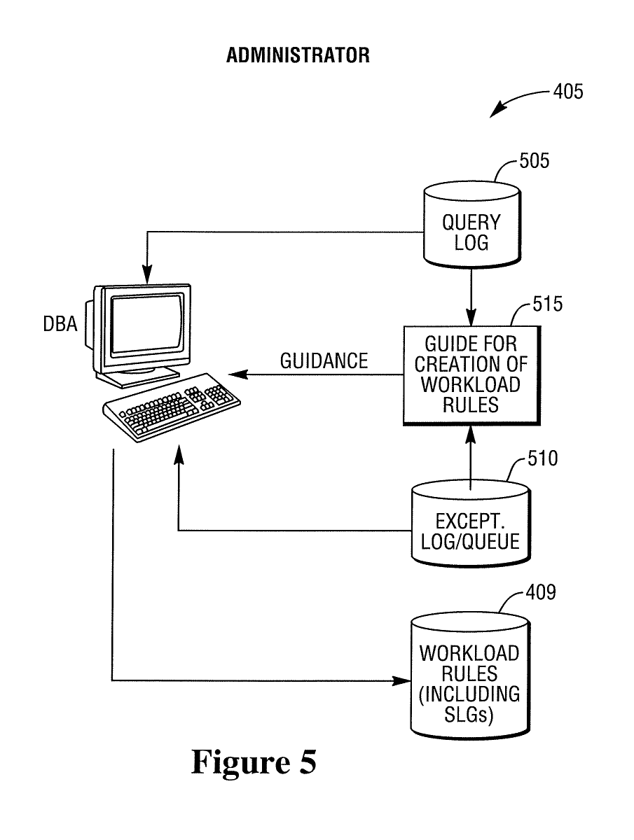

The system includes the following components (illustrated in FIG. 4):

1) Administrator (block 405): This component provides a graphical user interface (GUI) to define workloads and their SLGs and other workload management requirements. The administrator 405 accesses data in logs 407 associated with the system, including a query log, and receives capacity planning and performance tuning inputs as discussed above. The administrator 405 is a primary interface for the DBA. The administrator also establishes workload rules 409, which are accessed and used by other elements of the system.

2) Monitor (block 410): This component provides a top level dashboard view, and the ability to drill down to various details of workload group performance, such as aggregate execution time, execution time by request, aggregate resource consumption, resource consumption by request, etc. Such data is stored in the query log and other logs 407 available to the monitor. The monitor also includes processes that initiate the performance improvement mechanisms listed above and processes that provide long term trend reporting, which may include providing performance improvement recommendations. Some of the monitor functionality may be performed by the regulator, which is described in the next paragraph.

3) Regulator (block 415): This component dynamically adjusts system settings and/or projects performance issues and either alerts the DBA or user to take action, for example, by communication through the monitor, which is capable of providing alerts, or through the exception log, providing a way for applications and their users to become aware of, and take action on, regulator actions. Alternatively, the regulator can automatically take action by deferring requests or executing requests with the appropriate priority to yield the best solution given requirements defined by the administrator (block 405).

The workload management administrator (block 405), or “administrator,” is responsible for determining (i.e., recommending) the appropriate application settings based on SLGs. Such activities as setting weights, managing active work tasks and changes to any and all options will be automatic and taken out of the hands of the DBA. The user will be masked from all complexity involved in setting up the priority scheduler, and be freed to address the business issues around it.

As shown in FIG. 5, the workload management administrator (block 405) allows the DBA to establish workload rules, including SLGs, which are stored in a storage facility 409, accessible to the other components of the system. The DBA has access to a query log 505, which stores the steps performed by the DBS in executing a request along with database statistics associated with the various steps, and an exception log/queue 510, which contains records of the system's deviations from the SLGs established by the administrator. With these resources, the DBA can examine past performance and establish SLGs that are reasonable in light of the available system resources. In addition, the system provides a guide for creation of workload rules 515 which guides the DBA in establishing the workload rules 409. The guide accesses the query log 505 and the exception log/queue 510 in providing its guidance to the DBA.

The administrator assists the DBA in:

a) Establishing rules for dividing requests into candidate workload groups, and creating workload group definitions. Requests with similar characteristics (users, application, table, resource requirement, etc.) are assigned to the same workload group. The system supports the possibility of having more than one workload group with similar system response requirements.

b) Refining the workload group definitions and defining SLGs for each workload group. The system provides guidance to the DBA for response time and/or arrival rate threshold setting by summarizing response time and arrival rate history per workload group definition versus resource utilization levels, which it extracts from the query log (from data stored by the regulator, as described below), allowing the DBA to know the current response time and arrival rate patterns. The DBA can then cross-compare those patterns to satisfaction levels or business requirements, if known, to derive an appropriate response time and arrival rate threshold setting, i.e., an appropriate SLG. After the administrator specifies the SLGs, the system automatically generates the appropriate resource allocation settings, as described below. These SLG requirements are distributed to the rest of the system as workload rules.

c) Optionally, establishing priority classes and assigning workload groups to the classes. Workload groups with similar performance requirements are assigned to the same class. d) Providing proactive feedback (i.e., Validation) to the DBA regarding the workload groups and their SLG assignments prior to execution to better assure that the current assignments can be met, i.e., that the SLG assignments as defined and potentially modified by the DBA represent realistic goals. The DBA has the option to refine workload group definitions and SLG assignments as a result of that feedback.

During a database query (such as a relatively simple query), a relatively quick query response may be generated such that it falls outside the range of conforming to SLGs, especially when SLG range conformance is relatively tight. In accordance with disclosed embodiments, a response time variance reduction routine is provided for queries which have relatively short query response times. While the query response (i.e., answer set) is being processed for the query, a time delay (which may be a predetermined time delay) is provided so that the query response time does not fall outside the range of conforming to SLGs.

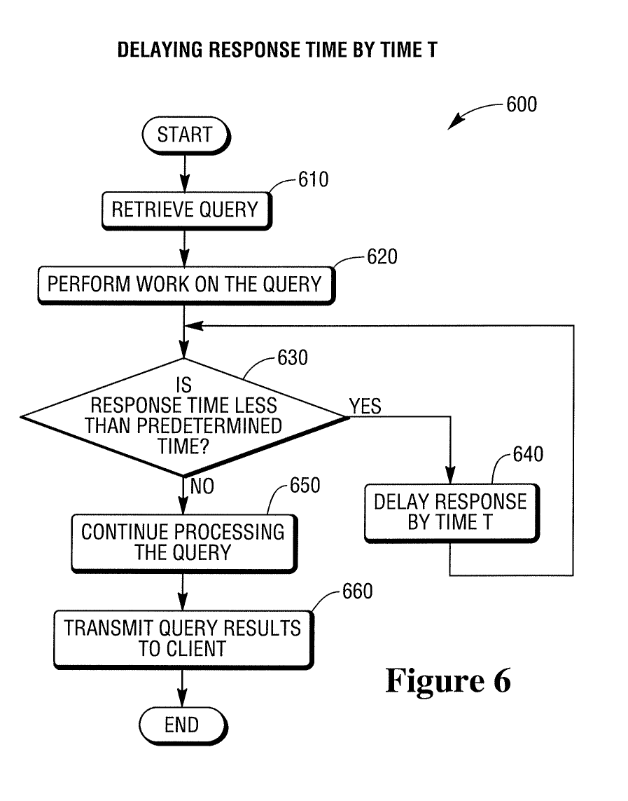

FIG. 6 is a flowchart 600 of an example response time variation reduction routine implemented in accordance with disclosed embodiments. The processing steps of FIG. 6 may be implemented as computer-executable instructions tangibly embodied on a computer-readable medium executable by a processing system, such as one or more of the processing modules 110₁-110_{N} depicted in FIG. 1.

In step 610, a database query (such as a relatively simple query) is received from either mainframe 135 or client computer system 140 (FIG. 1). At least some work is performed on the query received (step 620). The work performed may comprise completion of the main body of work on the particular query. Based upon the work performed on the query, a determination is made as to whether the query response time is less than a predetermined amount of time (step 630). If the determination in step 630 is affirmative (i.e., the query response time is less than the predetermined amount of time), then the process proceeds to step 640 in which a time delay “T” is added to the query response time. The process returns to step 630 to again determine if the delayed response time is less than the predetermined amount of time.

If the determination in step 630 is negative (i.e., the query response time is not less than the predetermined amount of time), then the process proceeds to step 650 to continue processing the query. After processing of the query is completed, query results are transmitted (step 660) to the client (i.e., either the mainframe 135 or the client computer system 140 shown in FIG. 1).

It should be apparent that the above description describes a deterministic response delay queue (DRDQ) mechanism within the workload management system for reducing response time variation. By reducing response time variation for certain queries (such as relatively simple queries) as described hereinabove, relatively tighter SLG ranges can be achieved. As an example, assume that a SLG is originally 7 seconds with 99% conformance, and that the average response time is 5 seconds, the low is 2 seconds, and the maximum time is 17 seconds. Also, assume that the database user requests that queries be completed within a range of 6 to 7 seconds 99% of the time. By providing the DRDQ mechanism described hereinabove, any queries that would have returned in less than 6 seconds would be delayed so that they will complete within the range of 6 to 7 seconds.

It should also be apparent that the above description describes a deterministic response filter (DRF) mechanism within the workload management system for achieving tighter SLG ranges. The relatively tighter SLG ranges are such that an exact response time may be approximated. As an example, assume that a database user requires a 2 second response time 99.9% of the time. This may be implemented as a range of 1.9 to 2.0 seconds. The limiting factor is the controllability and precision of the duration of the path from the DRDQ to the client. Accordingly, if it can be guaranteed that the last response parcel can be transmitted and received in less than 0.05 seconds, then it would be possible to delay any query that completes prior to 1.95 seconds and submit the last response parcel at exactly 1.95 seconds. Any query reaching the DRDQ in 1.95 seconds or more would not be subject to delay.

It is conceivable that selectable buckets of SLG ranges may be defined. As an example, a first range of up to 2 seconds, a second range between 2 and 5 seconds, and a third range of greater than 5 seconds may be provided. The number of selectable buckets of SLG ranges may comprise any number.

Some database users have a need to filter queries after query execution. Conditions can be set such that once information is known about the answer set, a filter can be applied. For example, it may be desired to filter queries which have an answer set larger than a specified size limit. The answer set size is not knowable until the query has been executed. If the answer set size is too large, it may be desirable to abort the query. It is possible that a time limit may be set on a query, such that if the query has taken longer than the specified time limit, it is desired that the query be aborted. Other such conditions may be specified at the point after execution of the query and preparation of the answer set, but prior to transmission to the client.

During a database query (such as a relatively complex query), query responses may be generated such that it falls outside of the range of conforming to SLGs, especially when SLG range conformance is relatively tight. When this occurs, the query may run longer than a certain specified time, or the query response may have an answer set size (such as in row count or bytes) that is larger than a specified limit. In accordance with disclosed embodiments, a query abort routing is provided for aborting such database queries. A higher conformance to SLGs is maintained when such database queries are aborted.

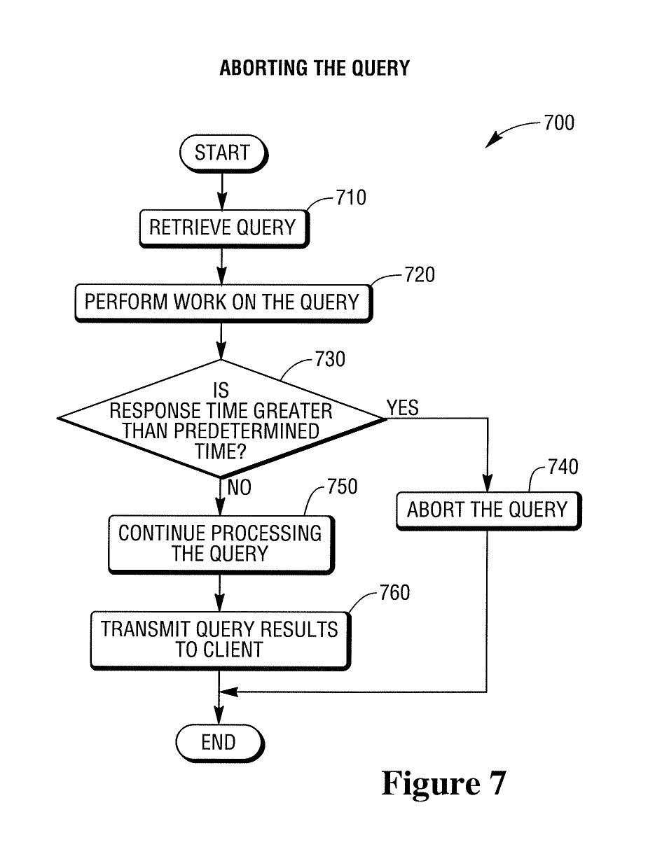

FIG. 7 is a flowchart 700 of an example query abort routine implemented in accordance with disclosed embodiments. The processing steps of FIG. 7 may be implemented as computer-executable instructions tangibly embodied on a computer-readable medium executable by a processing system, such as one or more of the processing modules 110₁-110_{N} depicted in FIG. 1.

In step 710, a database query (such as a relatively complex query) is received from either mainframe 135 or client computer system 140 (FIG. 1). At least some work is performed on the query received (step 720). The work performed may comprise completion of the main body of work on the particular query. Based upon the work performed on the query, a determination is made as to whether the query response time is greater than a predetermined amount of time (step 730). If the determination in step 730 is affirmative (i.e., the query response time is greater than the predetermined amount of time), then the process proceeds to step 740 in which the query is aborted. The process then ends.

If the determination in step 730 is negative (i.e., the query response time is not greater than the predetermined amount of time), then the process proceeds to step 750 to continue processing the query. After processing of the query is completed, query results are transmitted (step 760) to the client (i.e., either the mainframe 135 or the client computer system 140 shown in FIG. 1).

It should be apparent that the above description describes a DRF mechanism within the workload management system for achieving tighter SLG ranges. The relatively tighter SLG ranges are such that an exact response time may be approximated.

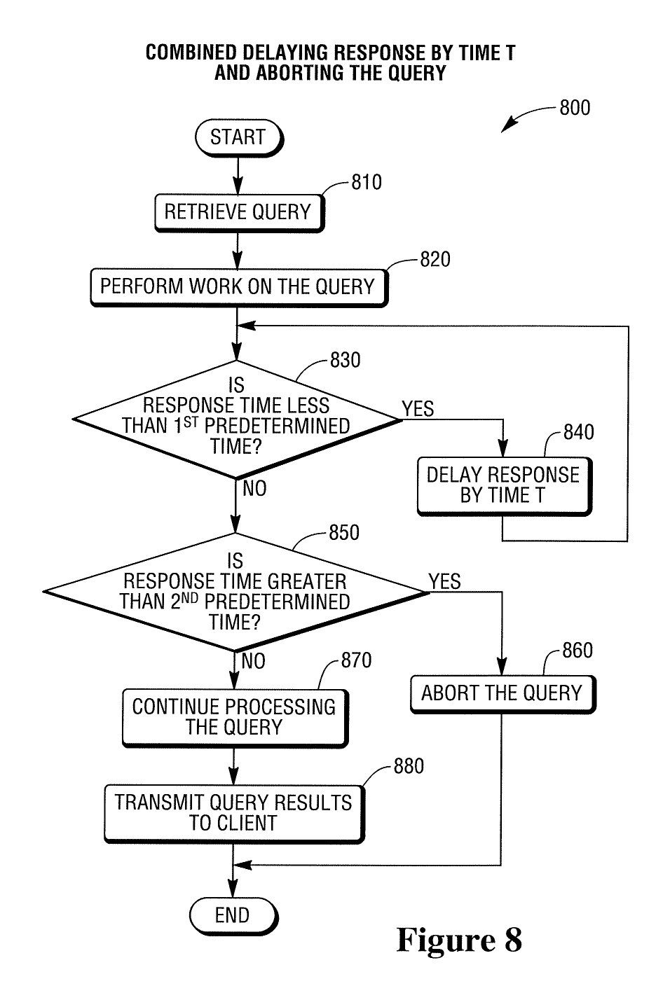

FIG. 8 is a flowchart 800 of an example combined response time variance reduction routine and query abort routine in accordance with disclosed embodiments. The processing steps of FIG. 8 may be implemented as computer-executable instructions tangibly embodied on a computer-readable medium executable by a processing system, such as one or more of the processing modules 110₁-110_{N} depicted in FIG. 1.

In step 810, a database query is received from either mainframe 135 or client computer system 140 (FIG. 1). At least some work is performed on the query received (step 820). The work performed may comprise completion of the main body of work on the particular query. Based upon the work performed on the query, a determination is made as to whether the query response time is less than a first predetermined amount of time (step 830). If the determination in step 830 is affirmative (i.e., the query response time is less than the first predetermined amount of time), then the process proceeds to step 840 in which a time delay “T” is added to the query response time. The process returns to step 830 to again determine if the delayed response time is less than the first predetermined amount of time.

If the determination in step 830 is negative (i.e., the query response time is not less than the first predetermined amount of time), then the process proceeds to step 850 in which a determination is made as to whether the query response time is greater than a second predetermined amount of time such that a predefined amount of time is defined between the first and second predetermined amounts of time. If the determination in step 850 is affirmative (i.e., the query response time is greater than the second predetermined amount of time), then the process proceeds to step 860 in which the query is aborted. The process then ends.

If the determination in step 850 is negative (i.e., the query response time is not greater than the second predetermined amount of time), then the process proceeds to step 870 to continue processing the query. After processing of the query is completed, query results are transmitted (step 880) to the client (i.e., either the mainframe 135 or the client computer system 140 shown in FIG. 1).

It should be apparent that the above description describes methods, computer-readable media, and systems that facilitate performance enhancement in a SLG-driven workload management system. The methods, media, and systems are applicable to a wide variety of queries during query execution. Tight SLG range conformance is provided with mechanisms that do not require holding of critical resources during database and query execution.

It should also be apparent that there are a number of control points at which the DRDQ mechanism, the DRF mechanism, or the combined deterministic response filter and delay queue (DRFDQ) mechanism can operate. As an example, a control point may be where the answer set has been generated, but prior to transmission of the answer set. As another example, a control point may be after the answer set has been transmitted, but prior to sending the last response parcel to complete the query to the client. DRFDQ settings may be changed via the TASM traffic cop mechanism (i.e., planned environments). Also, responses of delayed query response may be persisted through a restart operation.

Each of the above-described flowcharts depicts process serialization to facilitate an understanding of disclosed embodiments and is not necessarily indicative of the serialization of the operations being performed. In various embodiments, the processing steps described in each of the flowcharts above may be performed in varying order, and one or more depicted steps may be performed in parallel with other steps. Additionally, execution of some processing steps of each of the flowcharts above may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer.

The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information.

Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

The text above described one or more specific embodiments of a broader invention. The invention also is carried out in a variety of alternative embodiments and thus is not limited to those described here. For example, while the invention has been described here in terms of a DBS that uses a massively parallel processing (MPP) architecture, other types of database systems, including those that use a symmetric multiprocessing (SMP) architecture, are also useful in carrying out the invention. Many other embodiments are also within the scope of the following claims.

What is claimed is:

1. A database system comprising:
a processing module; and
a storage device communicatively coupled with the processing module, wherein the processing module is programmed to (i) receive a database query from a client, (ii) generate a query response to the database query, (iii) determine if response time of the query response is less than a first predetermined amount of time, and (iv) delay delivery of the query response to the client when an amount of time associated with the query response is less than the first predetermined amount of time.

2. A database system according to claim 1, wherein the processing module is further programmed to (v) determine if response time of the query response is greater than a second predetermined amount of time which is greater than the first predetermined amount of time, and (vi) abort the query when an amount of time associated with the query response is greater than the second predetermined amount of time.

3. A database system according to claim 1, wherein the predetermined amount of time is within a Service Level Goal (SLG) range specification of a workload management system for the database system.

4. A database system according to claim 1, wherein the delay of the predetermined amount of time is implemented after a main body of work has been completed on the query response for the particular query.

5. A method of processing a database query in a computer system, the method comprising:
receiving a database query from a client;
generating a query response to the database query;
determining if response time of the query response is less than a first predetermined amount of time; and
electronically by a processor, delaying delivery of the query response to the client when an amount of time associated with the query response is less than the first predetermined amount of time.

6. A method according to claim 5, further comprising:
determining if the response time of the query response is greater than a second predetermined amount of time; and
electronically by a processor, aborting the query when an amount of time associated with the query response is greater than the second predetermined amount of time.

7. A method according to claim 6, wherein the second predetermined amount of time is greater than the first predetermined amount of time such that a predefined amount of time is defined between the first and second predetermined amounts of time.

8. A method according to claim 5, wherein the method is performed by a computer having a memory executing one or more programs of instructions which are tangibly embodied in a program storage medium readable by the computer.

9. A method of processing a database query in a computer system, the method comprising:
receiving a database query from a client;
generating a query response to the database query;
determining if response time of the query response is greater than a predetermined amount of time; and
electronically by a processor, aborting the query when an amount of time associated with the query response is greater than the predetermined amount of time.

10. A method according to claim 9, wherein the predetermined amount of time is within a Service Level Goal (SLG) range specification of a workload management system for the database system.

11. A method according to claim 9, wherein the method is performed by a computer having a memory executing one or more programs of instructions which are tangibly embodied in a program storage medium readable by the computer.
